(19) United States
(12) Patent Application Publication
(10) Pub. No.: US 2025/0197228 A1
(43) Pub. Date: Jun. 19, 2025

(54) METHOD FOR SIMULTANEOUSLY PREPARING NANO SPHERICAL OXIDE FILLER AND SUBMICRON SPHERICAL OXIDE FILLER

(71) Applicant: NOVORAY CORPORATION, Jiangsu (CN)

(72) Inventors: Jianping ZHANG, Jiangsu (CN); Jiakai CAO, Jiangsu (CN); Xiaodong LI, Jiangsu (CN); Baoqi FENG, Jiangsu (CN)

(21) Appl. No.: 18/265,940

(22) PCT Filed: Dec. 16, 2022
(86) PCT No.: PCT/CN2022/139432

§ 371 Date: Feb. 19, 2025

(30) Foreign Application Priority Data
Oct. 18, 2022 (CN) 202211271930.1

(51) Int. Cl. C01B 33/18

(52) U.S. Cl. CPC C01B 33/181; C01P 2004/32; C01P 2004/61; C01P 2004/62; C01P 2004/64

(57) ABSTRACT

The disclosure relates to the technical field of spherical oxide fillers and provides a method for simultaneously preparing a nano spherical oxide filler and a submicron spherical oxide filler. In the disclosure, a composite treatment of oxide raw material (raw material O) and metallic or non-metallic raw material (raw material M) is adopted to reduce the reactivity of raw materials, thereby reducing the risk of uncontrollable dust deflagration, and achieving safe production. Further, raw material O undergoes gasification under high temperature conditions to form nano-scale particles, or is dispersed into nano-scale particles by a shock wave formed by deflagration; and raw material M reacts with oxygen in an oxygen-enriched state, and undergoes coalescence and cooling to form submicron-scale particles. Product particles obtained from a combustion reaction are cooled into sphere-shaped particles under oxygen-enriched conditions, and the sphere-shaped particles obtained are subjected to fine separation to simultaneously obtain the submicron spherical oxide filler and the nano spherical oxide filler. Also, after a temperature in a reactor is stabilized, a fuel gas is reduced to the minimum, thereby stabilizing a temperature in a reactor while reducing cost.

This patent application claims the priority of Chinese patent application No. CN202211271930.1, entitled “Method for simultaneously preparing nano spherical oxide filler and submicron spherical oxide filler” filed with the China National Intellectual Property Administration on Oct. 18, 2022, which is incorporated herein by reference in its entirety.

### TECHNICAL FIELD

The present disclosure relates to the technical field of spherical oxide fillers, in particular to a method for simultaneously preparing a nano spherical oxide filler and a submicron spherical oxide filler.

### BACKGROUND ART

For electronic packaging devices, properties of the system, such as the thermal expansion coefficient, dielectric properties, moisture resistance, and stress, are improved by the addition of fillers. In recent years, electronic devices have been developed in the direction of lightweight and small size, which requires a desirably smaller particle size of the fillers. Therefore, the miniaturization of the filler particle size is imperative.

Currently, the methods for producing nano and submicron fillers mainly include liquid phase synthesis method, plasma method, gasification method, and flame method. As to the liquid phase synthesis method, the use of organic solvents is not environmentally friendly, and the method has high cost, and a long production cycle, making it difficult to obtain cost-effective products in batches. The plasma method involves physical processes, considering its high operating cost and low productivity, there is great difficulty in large-scale production. The gasification method utilizes high heat focusing from light sources such as lasers to obtain submicron-scale products. However, these methods are currently in developing and the stability of the products produced is poor. The flame method is one of the main methods for preparing spherical oxide fillers currently. This method is preformed by feeding the filler into a high-temperature environment formed by combustible gas(s) and oxygen, and conducting high-temperature melting and cooling, thereby forming a spherical oxide filler due to the action of surface tension.

In 1990, in the United States Patent (U.S. Pat. No. 4,923,520) combustible propane and oxygen as the combustion-supporting agent are used to form a high-temperature flame to spheroidize angular silicon dioxide powder, but this method only results in a product with an average particle size of 10-50 μm. After continuous improvement, in the actual production process, products with an average particle size about 3 μm could be obtained. However, for products with an average particle size less than 3 μm, the method fails.

In the patent No. JP2009263154 disclosed by Adatechs Co., Ltd., silicon is used as the raw material and the principle of dust explosion is adopted to prepare a spherical silica micron powder with an average particle size of 0.5 μm, and a specific surface area of 6.0 m²/g. In patent JP4132610 by Shin-Etsu Chemical Co., Ltd., silicon powder is combusted in an oxygen containing stream, forming a spherical silica powder with an average particle size of 0.1-10 μm. In the above patents, silicon is used as the raw material. Considering that metals are prone to dust explosion under high temperature and oxygen enriched conditions, which is not safe for plant design, equipment, and personnel, this process is rarely used to produce submicron silicon oxide products in China.

Therefore, there is an urgent need in the field for a method for simultaneously preparing a nano spherical oxide filler and a submicron spherical oxide filler with good safety.

### SUMMARY

In view of this, the present disclosure is to provide a method for simultaneously preparing a nano spherical oxide filler and a submicron spherical oxide filler. With the method according to the present disclosure, a nano spherical oxide filler and a submicron spherical oxide filler could be prepared simultaneously, with good safety.

In order to achieve the above object of the present disclosure, the present disclosure provides the following technical solutions.

Provided is a method for simultaneously preparing a nano spherical oxide filler and a submicron spherical oxide filler, which comprises the following steps:
subjecting a first raw material and a second raw material to a combustion reaction in the presence of a fuel gas and a combustion supporting gas to obtain a combustion product; the first raw material being one selected from the group consisting of a metallic elementary substance powder, a non-metallic elementary substance powder, and an alloy powder, and the second raw material being an oxide or a composite oxide corresponding to the first raw material, wherein the first raw material has a particle size of 3-300 μm, and the second raw material has a particle size of 30 nm to 10 μm, and the second raw material accounts for not more than 30% of a total mass of the first raw material and the second raw material; and
cooling the combustion product, to obtain a cooled combustion product, and subjecting the cooled combustion product to fine separation, to obtain the submicron spherical oxide filler and the nano spherical oxide filler.

In some embodiments, for the combustion reaction, the first raw material and the second raw material are fed by mixing the first raw material and the second raw material and then feeding, and the mixing is performed by a dry mixing or a liquid phase mixing.

In some embodiments, the liquid phase mixing is preformed by mixing the first raw material, the second raw material, and a solvent, and then drying to obtain a mixed powder.

In some embodiments, the solvent is one or more selected from the group consisting of water, methanol, ethanol, acetone, and butanone; and the drying is preformed at a temperature of 100-200° C. for 2-30 h.

In some embodiments, a device used for the dry mixing comprises one selected from the group consisting of a V-shaped mixer, a double cone mixer, a pneumatic mixer, a conical mixer, a high-speed mixer, and an air flow mixer.

In some embodiments, the first raw material and the second raw material are first mixed and then fed at a feed rate of 1.7-1020 g/min.

In some embodiments, for the combustion reaction, the first raw material and the second raw material are fed separately, wherein the first raw material is fed at a feed rate of 1.7-700 g/min, and the second raw material is fed at a feed rate of not larger than 250 g/min.

In some embodiments, during the combustion reaction, after the temperature in a reactor is stabilized, an inflow rate of the fuel gas is reduced to 2-10% of an initial inflow rate of the fuel gas, wherein it is considered that the temperature is stabilized when a temperature fluctuation in the reactor does not exceed 10° C.

In some embodiments, the initial inflow rate of the fuel gas is 50 m³/h, and after the temperature in the reactor is stabilized, the inflow rate of the fuel gas is reduced to 2 m³/h.

In some embodiments, the metallic elementary substance powder comprises one or more of aluminum, magnesium, iron, copper, titanium, zirconium, and zinc; the non-metallic elementary substance powder is silicon; and the alloy powder is one or more selected from the group consisting of an aluminum iron alloy powder, an aluminum silicon alloy powder, an aluminum magnesium alloy powder, a magnesium alloy powder, and a silicon iron alloy powder.

In some embodiments, the fine separation comprises one or more of cyclone classification, airflow classification, overflow classification, and screening classification.

In some embodiments, the submicron spherical oxide filler has a D₅₀ particle size of 0.1-1.5 μm, and the nano spherical oxide filler has a D₅₀ particle size of 10-100 nm.

In some embodiments, the fuel gas comprises one or more of hydrogen, liquefied natural gas, liquefied petroleum gas, acetylene, and propane; and the combustion supporting gas comprises one or both of oxygen and air.

The present disclosure provides a method for simultaneously preparing a nano spherical oxide filler and a submicron spherical oxide filler, including the following steps: subjecting a first raw material and a second raw material to a combustion reaction in the presence of a fuel gas and a combustion supporting gas to obtain a combustion product; the first raw material being one selected from the group consisting of a metallic elementary substance powder, a non-metallic elementary substance powder, and an alloy powder, and the second raw material being an oxide or a composite oxide corresponding to the first raw material; and cooling the combustion product, to obtain a cooled combustion product, and subjecting the cooled combustion product to fine separation, to obtain the submicron spherical oxide filler and the nano spherical oxide filler. In the present disclosure, an oxide raw material (the second raw material, recorded as raw material O) and a metallic or non-metallic raw material (the first raw material, recorded as raw material M) are composited to reduce the reactivity of the resulting mixed raw material (recorded as raw material MO), thereby reducing the risk of uncontrollable dust deflagration and achieving safe production. Meanwhile, raw material O undergoes gasification under high temperature conditions to form nano-scale particles, or is dispersed into nano-scale particles by the shock wave formed by deflagration; raw material M reacts with oxygen in an oxygen-enriched state, and undergoes coalescence and cooling to form submicron-scale particles. The product particles obtained from the combustion reaction are cooled under high temperature and oxygen-enriched conditions, forming sphere-shaped particles under the action of surface tension. The raw materials M and O form submicron- and nano-scale particles, respectively. The mixed particles are subjected to fine separation, to simultaneously obtain the submicron spherical oxide filler and the nano spherical oxide filler.

Further, raw material M reacts with oxygen to release a large amount of heat, which can be used to maintain the subsequent reaction. Therefore, in the present disclosure, the fuel gas is reduced to the minimum after the temperature in the reactor is stabilized, thereby stabilizing the temperature in the reactor while reducing cost.

### DETAILED DESCRIPTION OF THE EMBODIMENTS

The present disclosure provides a method for simultaneously preparing a nano spherical oxide filler and a submicron spherical oxide filler, comprising the following steps:
subjecting a first raw material and a second raw material to a combustion reaction in the presence of a fuel gas and a combustion supporting gas to obtain a combustion product; the first raw material being one selected from the group consisting of a metallic elementary substance powder, a non-metallic elementary substance powder, or an alloy powder, and the second raw material being an oxide or a composite oxide corresponding to the first raw material, wherein the first raw material has a particle size of 3-300 μm, and the second raw material has a particle size of 30 nm to 10 μm, and the second raw material accounts for not more than 30% of a total mass of the first raw material and the second raw material; and
cooling the combustion product, to obtain a cooled combustion product, and subjecting the cooled combustion product to fine separation, to obtain the submicron spherical oxide filler and the nano spherical oxide filler.

In the present disclosure, the first raw material and the second raw material are subjected to a combustion reaction in the presence of a fuel gas and a combustion supporting gas to obtain a combustion product. In the present disclosure, the first raw material is a metallic elementary substance powder, a non-metallic elementary substance powder, or an alloy powder. In some embodiments, the metallic elementary substance powder comprises one or more of aluminum, magnesium, iron, copper, titanium, zirconium, and zinc. In some embodiments, the non-metallic elementary substance powder is silicon. In some embodiments, the alloy powder is one or more selected from the group consisting of an aluminum iron alloy powder, an aluminum silicon alloy powder, an aluminum magnesium alloy powder, a magnesium alloy powder, and a silicon iron alloy powder. In some embodiments, the second raw material is an oxide corresponding to the first raw material, for example, when the first raw material is aluminum powder (Al), the second raw material is aluminum oxide powder (Al₂O₃); when the first raw material is silicon powder (Si), the second raw material is silicon oxide powder (SiO₂); and when the first raw material is an aluminum silicon alloy, the second raw material is a mixture of aluminum oxide powder and silicon oxide powder (i.e., a composite oxide). In the present disclosure, the first raw material is recorded as raw material M, the second raw material is recorded as raw material O, and the mixed raw material of the first and second raw material is recorded as raw material MO.

In the present disclosure, raw material M has an average particle size of 3-300 μm. Specifically, it may be 3 μm, 5 μm, 15 μm, 35 μm, 50 μm, 100 μm, 200 μm or 300 μm. Raw material O has an average particle size of 30 nm to 10 μm. Specifically, it may be 30 nm, 100 nm, 1 μm, 3 μm, 5 μm or 10 μm.

In the present disclosure, the mass of raw material O is not more than 30% of the total mass of raw material M and raw material O. Specifically, it may be greater than 0 but less than or equal to 30%, preferably 5 to 25%, and further preferably 10 to 20%.

In some embodiments of the present disclosure, for the combustion reaction, the first raw material and the second raw material are fed by mixing raw material M and raw material O and then feeding, or feeding raw material M and raw material O separately. In some embodiments, when feeding after mixing is adopted, raw material M and raw material O is mixed by a dry mixing or a liquid phase mixing. In some embodiments, a device used for the dry mixing includes a V-shaped mixer, a double cone mixer, a pneumatic mixer, a cone mixer, a high-speed mixer, or an air flow mixer. In some embodiments, the liquid phase mixing is performed by mixing raw material M, raw material O, and a solvent, and then drying to obtain a mixed powder (i.e., raw material MO). In some embodiments, the solvent is one or more selected from the group consisting of water, methanol, ethanol, acetone, and butanone. In some embodiments, a device used for the liquid phase mixing is the same as the device used for the dry mixing. In some embodiments, after mixing, the resulting mixture is dried at 100-200° C. for 2-30 hours, to completely remove the solvent. In the present disclosure, there is no special requirements for the volume of solvent used in the liquid phase mixing process, as long as raw material M and raw material O could be uniformly mixed.

In the specific embodiments of the present disclosure, when feeding after mixing is adopted, raw material MO is fed at a feed rate of 1.7-1020 g/min.

In some embodiments of the present disclosure, when raw material M and raw material O are fed separately, raw materials (i.e., raw material M and raw material O) from different silos are passed into a combustion reaction vessel at a certain rate, and the mass of raw material O in the reaction vessel is controlled to be not more than 30% of the total mass of raw material M and raw material O by adjusting the passing rates of raw material M and raw material O. In the specific embodiments of the present disclosure, when raw material M and raw material O are fed separately, raw material M is fed at a feed rate of 1.7-700 g/min, and raw material O is fed at a feed rate of not larger than 250 g/min, preferably 0.5-250 g/min.

In some embodiments of the present disclosure, the fuel gas comprises one or more of hydrogen, liquefied natural gas, liquefied petroleum gas, acetylene, and propane. In some embodiments, the combustion supporting gas comprises one or both of oxygen and air. In some embodiments, a container for the combustion reaction is a reaction furnace. In some embodiments of the present disclosure, the fuel gas and the combustion supporting gas are first fed into a reaction furnace for combustion, and raw material MO is then fed or raw material M and raw material O are fed separately; raw material MO reacts in a high-temperature flame formed by the fuel gas and the combustion supporting gas. Raw material MO splits instantaneously in an oxygen-enriched state and high temperature conditions, and raw material M encapsulated therein combusts with oxygen, releasing a large amount of heat, resulting in a continuous rise in temperature. In some embodiments of the present disclosure, the inflow rate of the fuel gas is reduced to 2-10% of the initial inflow rate after the temperature in the reactor is stabilized. In the specific embodiments of the present disclosure, it is considered that the temperature is stabilized, when the temperature fluctuation in the reactor does not exceed 10° C. In the present disclosure, the operations as described above are adopted, thereby saving fuel gas, reducing cost, and meanwhile controlling the temperature equilibrium in the reactor. In some embodiments, the inflow rate of the combustion supporting gas is calculated according to the stoichiometric ratio in relative to the fuel gas. In specific embodiments of the present disclosure, the amount of the combustion supporting gas is reduced as the amount of the fuel gas decreases. In the specific embodiments of the present disclosure, the initial inflow rate of the fuel gas is 50 m³/h, and the initial inflow rate of the combustion supporting gas is 150 m³/h, and after the temperature in the reactor is stabilized, the inflow rate of the fuel gas is reduced to 2 m³/h, and the inflow rate of the combustion supporting gas is reduced to 15 m³/h.

During the combustion reaction process, raw material O undergoes gasification under high temperature conditions to form nano-scale particles, or is dispersed into nano-scale particles by the shock wave formed by deflagration; and raw material M reacts with oxygen in an oxygen-enriched state, and undergoes coalescence and cooling to form submicron particles. Thus, the resulting combustion product is a mixture of nano-scale oxide particles and submicron-scale oxide particles.

According to the present disclosure, after obtaining the combustion products, the combustion products are cooled and the cooled combustion products are subjected to fine separation to obtain the submicron spherical oxide filler and the nano spherical oxide filler. In some embodiments of the present disclosure, the cooling is performed by air cooling. During the cooling process, the nano-scale particles and submicron-scale particles become spherical under the action of surface tension, forming nano spherical oxide particles and submicron spherical oxide particles. In some embodiments of the present disclosure, means for the fine separation includes one or more of cyclone classification, airflow classification, overflow classification, and screening classification. In the present disclosure, there is no special requirements on the specific operating conditions for the above means, and any conditions well known to those skilled in the art may be used, as longs as products of different particle sizes could be separated from each other. The coarse powder segment obtained from the fine separation corresponds to the submicron spherical oxide filler, while the fine powder segment corresponds to the nano spherical oxide filler. In the present disclosure, the submicron spherical oxide filler has an average particle size of 0.1-1.5 μm, and the nano spherical oxide filler has an average particle size of 10-100 nm.

The following will provide a clear and complete description of the technical solutions of the present disclosure in conjunction with the examples of the present disclosure. Obviously, the described examples are only a part of the examples of the present disclosure, not all of them. Based on the examples in the present disclosure, all other examples obtained by persons of ordinary skill in the art without creative labor should fall within the scope of the present disclosure.

The fuel gas used in the following examples was natural gas, and the combustion supporting gas was oxygen.

### Example 1

700 g of raw material Si powder with a D₅₀ of 5 μm and 300 g of raw material SiO₂ powder with a D₅₀ of 0.1 μm were homogenized and composited in an air flow mixer for 3 h, obtaining a mixed raw material Si—SiO₂. The mixed raw material was fed into a high-temperature container (which was charged with the fuel gas and oxygen in advance) and reacted therein (the feed rate of the mixed raw material was 60 g/min, the initial inflow rate of the fuel gas was 50 m³/h, and the inflow rate of the combustion supporting gas was 150 m³/h). After reaction for 2 hours, the inflow rate of the fuel gas was reduced to 2 m³/h, and the inflow rate of the combustion supporting gas was reduced to 15 m³/h. The products obtained from the reaction were cooled and subjected to fine separation, obtaining a submicron spherical silica filler (with a D₅₀ of 0.7 μm) and a nano spherical silica filler (with a D₅₀ of 80 nm).

### Example 2

950 g of raw material Si powder with a D₅₀ of 300 μm and 50 g of raw material SiO₂ powder with a D₅₀ of 10 μm were homogenized and composited in an air flow mixer for 3 h, obtaining a mixed raw material Si—SiO₂. The mixed raw material was fed into a high-temperature container (which was charged with the fuel gas and oxygen) and reacted therein (the feed rate of the mixed raw material was 60 g/min, the initial inflow rate of the fuel gas was 50 m³/h, and the inflow rate of the combustion supporting gas was 150 m³/h). After reaction for 2 hours, the inflow rate of the fuel gas was reduced to 2 m³/h, and the inflow rate of the combustion supporting gas was reduced to 15 m³/h. The products obtained from the reaction were cooled and subjected to fine separation, obtaining a submicron spherical silica filler (with a D₅₀ of 0.4 μm) and a nano spherical silica filler (with a D₅₀ of 60 nm).

### Example 3

800 g of raw material Al powder with a D₅₀ of 15 μm and 200 g of raw material Al₂O₃ powder with a D₅₀ of 30 nm were homogenized and composited in a V-shaped mixer for 3 h (in a protective environment of an inert gas), obtaining a mixed raw material Al—Al₂O₃. The mixed raw material was fed into a high-temperature container (which was charged with the fuel gas and oxygen in advance) and reacted therein (the feed rate of the mixed raw material was 60 g/min, the initial inflow rate of the fuel gas was 50 m³/h, and the inflow rate of the combustion supporting gas was 150 m³/h). After reaction for 2 hours, the inflow rate of the fuel gas was reduced to 2 m³/h, and the inflow rate of the combustion supporting gas was reduced to 15 m³/h. The products obtained from the reaction were cooled and subjected to fine separation, obtaining a submicron spherical silica filler (with a D₅₀ of 0.2 μm) and nano spherical silica filler (with a D₅₀ of 50 nm).

### Example 4

700 g of raw material Al powder with a D₅₀ of 15 μm and 300 g of raw material Al₂O₃ powder with a D₅₀ of 40 nm were respectively fed into a high-temperature container (which was charged with the fuel gas and oxygen in advance) and reacted therein (the feed rate of Al powder was 42 g/min, the feed rate of Al₂O₃ powder was 18 g/min, the initial inflow rate of the fuel gas was 50 m³/h, and the inflow rate of the combustion supporting gas was 150 m³/h). After reaction for 2 hours, the inflow rate of the fuel gas was reduced to 2 m³/h, and the inflow rate of the combustion supporting gas was reduced to 15 m³/h. The products obtained from the reaction were cooled and subjected to fine separation, obtaining a submicron spherical silica filler (with a D₅₀ of 0.4 μm) and nano spherical silica filler (with a D₅₀ of 20 nm).

### Comparative Example 1 (Omitting Raw Material M)

1000 g of raw material Si powder with a D₅₀ of 12 μm was fed into a high-temperature container (which was charged with the fuel gas and enriched oxygen in advance) and reacted therein (the feed rate of Si powder was 60 g/min, the initial inflow rate of the fuel gas was 50 m³/h, and the inflow rate of the combustion supporting gas was 150 m³/h). After reaction for 2 hours, the inflow rate of the fuel gas was reduced to 2 m³/h. Finally, a spherical silica filler with a D₅₀ of 0.8 μm was obtained.

### Comparative Example 2 (Increasing the Proportion of Raw Material O)

500 g of raw material Si powder with a D₅₀ of 35 μm and 500 g of raw material SiO₂ powder with a D₅₀ of 3.0 μm were homogenized and composited at a high speed in an air flow mixer for 3 h, obtaining a mixed raw material Si—SiO₂. The mixed raw material was fed into a high-temperature container (which was charged with the fuel gas and oxygen in advance) and reacted therein (the feed rate of the mixed raw material was 60 g/min, the initial inflow rate of the fuel gas was 50 m³/h, and the inflow rate of the combustion supporting gas was 150 m³/h). After reaction for 2 hours, the inflow rate of the fuel gas was reduced to 2 m³/h, and the inflow rate of the combustion supporting gas was reduced to 15 m³/h. The products obtained from the reaction were cooled and subjected to fine separation, obtaining a micron spherical silica filler (with a D₅₀ of 2.7 μm) and a nano spherical silica filler (with a D₅₀ of 80 nm).

### Comparative Example 3 (Omitting the Operation of Reducing the Inflow Rate of the Fuel Gas)

700 g of raw material Si powder with a D₅₀ of 5 μm and 300 g of raw material SiO₂ powder with a D₅₀ of 0.1 μm were homogenized and composited at a high speed in an air flow mixer for 3 h, obtaining a mixed raw material Si—SiO₂. The mixed raw material was fed into a high-temperature container (which was charged with the fuel gas and enriched oxygen in advance) and reacted therein. The feed rate of the mixed raw material was 60 g/min, the inflow rate of the fuel gas was maintained at 50 m³/h, and the inflow rate of the combustion supporting gas was maintained at 150 m³/h. The products obtained from the reaction were cooled and subjected to fine separation, obtaining a submicron spherical silica filler (with a D₅₀ of 0.8 μm) and a nano spherical silica filler (with a D₅₀ of 82 nm).

### Comparative Example 4 (Increasing the Particle Size of Raw Material M)

700 g of raw material Si with a D₅₀ of 350 μm, and 300 g of raw material SiO₂ with a D₅₀ of 6 μm were homogenized and composited at a high speed in an air flow mixer for 3 h, obtaining a mixed raw material Si—SiO₂. The mixed raw material was fed into a high-temperature container (which was charged with the fuel gas and oxygen in advance) and reacted therein (the feed rate of the mixed raw material was 60 g/min, the initial inflow rate of the fuel gas was 50 m³/h, and the inflow rate of the combustion supporting gas was 150 m³/h). After reaction for 2 hours, the inflow rate of the fuel gas was reduced to 2 m³/h, and the inflow rate of the combustion supporting gas was reduced to 15 m³/h. The products obtained from the reaction were cooled and subjected to fine separation, obtaining a gray product and spherical silica filler with a D₅₀ of 60 nm.

### Performance Test:

In the present disclosure, a composite treatment of raw material M and raw material O is adopted to reduce the reactivity of raw materials. The reactivity of the raw material was characterized by an explosive pressure ratio PR (the smaller value implies a lower explosive risk). Due to the large amount of heat released by the reaction between raw material M with oxygen, in the present disclosure, the fuel gas is reduced to reduce the cost and control the stability of temperature in the container, making the reaction more gentle. The temperature changes of the inner wall of the container during the reaction in Examples 1 to 4 and the Comparative Examples 1 to 4 were monitored. In addition, the particle size distributions of the obtained spherical oxide fillers were characterized by using a laser particle size analyzer.

The test results are shown in Table 1.

TABLE 1
Test results of Examples 1 to 4 and Comparative Examples 1 to 4

| | Par- | Par- | | Pres- | Par- | Par- | |
|---|---|---|---|---|---|---|---|
| | ticle | ticle | | sure | ticle | ticle | |
| | size of | size of | | ratio | size | size | |
| | raw | raw | Pro- | of raw | of | of | |
| | ma- | ma- | portion | material | pro- | pro- | Tem- |
| | terial | terial | of raw | MO or | duct | duct | per- |
| | M | O | ma- | raw | 1, | 2, | ature |
| | D₅₀, | D₅₀, | terial | material | D₅₀, | D₅₀, | change |
| Items | μm | μm | O, % | M, PR | μm | μm | % |
| Example 1 | 5 | 0.1 | 30 | 1.6 | 0.7 | 80 | 2 |
| Example 2 | 300 | 10.0 | 5 | 1.8 | 0.4 | 60 | 5 |
| Example 3 | 15 | 0.03 | 20 | 2.6 | 0.2 | 50 | 3 |
| Example 4 | 15 | 0.04 | 30 | 6.5 | 0.4 | 20 | 10 |
| Com- | 12 | None | 0 | 5.2 | 0.8 | No | 1 |
| parative | | | | | | pro- | |
| Example 1 | | | | | | duct | |
| Com- | 35 | 3.0 | 50 | 1.4 | 2.7 | 80 | 10 |
| parative | | | | | | | |
| Example 2 | | | | | | | |
| Com- | 5 | 0.1 | 30 | 1.6 | 0.8 | 82 | 15 |
| parative | | | | | | | |
| Example 3 | | | | | | | |
| Com- | 350 | 6 | 30 | 1.3 | Gray | 60 | 5 |
| parative | | | | | power | | |
| Example 4 | | | | | | | |

It can be seen from Table 1 that: (1) In Comparative Example 1, Si powder alone is used as the raw material, and the PR value of the raw material is high, indicating that the reaction is intense and there is a high risk to production safety; also, only submicron-scale products are obtained, making it difficult to obtain nano-scale products. (2) In Comparative Example 2, the proportion of raw material O is increased to 50%, and thus raw material O is not completely gasified or dispersed, resulting in that product 1 has a coarse particle size, as a micron-scale product, making it difficult to obtain submicron-scale products. (3) In Comparative Example 3, the fuel gas is not reduced to the minimum, and it leads to an increase in the product cost by 15% to 25%, and an increase in the inner wall temperature of the container by 15% to 30%, resulting in high product cost and hindered continuous production. (4) In Comparative Example 4, the raw material Si powder has a particle size reaching 350 μm, and enters the product due to incomplete reaction in the high temperature zone, causing the product to appear gray.

In addition, by observing the appearance of the submicron- and nano-scale products obtained in Examples 1 to 4, it shows that both of the submicron- and nano-scale products are sphere-shaped, in a uniform size.

The above are only preferred embodiments of the disclosure. It should be pointed out that for persons of ordinary skill in the art, several improvements and embellishments can be made without departing from the principles of the present disclosure, and these improvements and embellishments should fall within the scope of the present disclosure.

What is claimed is:

1. A method for simultaneously preparing a nano spherical oxide filler and a submicron spherical oxide filler, comprising steps of
subjecting a first raw material and a second raw material to a combustion reaction in the presence of a fuel gas and a combustion supporting gas to obtain a combustion product; the first raw material being one selected from the group consisting of a metallic elementary substance powder, a non-metallic elementary substance powder, and an alloy powder, and the second raw material being an oxide or a composite oxide corresponding to the first raw material, wherein the first raw material has a particle size of 3-300 μm, and the second raw material has a particle size of 30 nm to 10 μm, and the second raw material accounts for not more than 30% of a total mass of the first raw material and the second raw material; and
cooling the combustion product, to obtain a cooled combustion product, and subjecting the cooled combustion product to fine separation, to obtain the submicron spherical oxide filler and the nano spherical oxide filler.

2. The method as claimed in claim 1, wherein for the combustion reaction, the first raw material and the second raw material are fed by mixing the first raw material and the second raw material and then feeding, and the mixing is performed by a dry mixing or a liquid phase mixing.

3. The method as claimed in claim 2, wherein the liquid phase mixing is preformed by mixing the first raw material, the second raw material, and a solvent, and then drying to obtain a mixed powder.

4. The method as claimed in claim 3, wherein the solvent is one or more selected from the group consisting of water, methanol, ethanol, acetone, and butanone; and the drying is preformed at a temperature of 100-200° C. for 2-30 h.

5. The method as claimed in claim 3, wherein a device used for the dry mixing comprises one selected from the group consisting of a V-shaped mixer, a double cone mixer, a pneumatic mixer, a cone mixer, a high-speed mixer, and an air flow mixer.

6. The method as claimed in claim 2, wherein the first raw material and the second raw material are first mixed and then fed at a feed rate of 1.7 g/min to 1020 g/min.

7. The method as claimed in claim 2, wherein for the combustion reaction, the first raw material and the second raw material are fed separately, wherein the first raw material is fed at a feed rate of 1.7 g/min to 700 g/min, and the second raw material is fed at a feed rate of not larger than 250 g/min.

8. The method as claimed in claim 1, wherein during the combustion reaction, after a temperature in a reactor is stabilized, an inflow rate of the fuel gas is reduced to 2-10% of an initial inflow rate of the fuel gas, wherein it is considered that the temperature is stabilized when a temperature fluctuation in the reactor does not exceed 10° C.

9. The method as claimed in claim 1 or 8, wherein the initial inflow rate of the fuel gas is 50 m³/h, and after the temperature in the reactor is stabilized, the inflow rate of the fuel gas is reduced to 2 m³/h.

10. The method as claimed in claim 1, wherein the metallic elementary substance powder comprises one or more of aluminum, magnesium, iron, copper, titanium, zirconium, and zinc;
the non-metallic elementary substance powder is silicon; and
the alloy powder is one or more selected from the group consisting of an aluminum iron alloy powder, an aluminum silicon alloy powder, an aluminum magnesium alloy powder, a magnesium alloy powder, and a silicon iron alloy powder.

11. The method as claimed in claim 1, wherein the fine separation comprises one or more of cyclone classification, airflow classification, overflow classification, and screening classification.

12. The method as claimed in claim 1 or 11, wherein the submicron spherical oxide filler has a D₅₀ particle size of 0.1-1.5 μm, and the nano spherical oxide filler has a D₅₀ particle size of 10-100 nm.

13. The method as claimed in claim 1 or 8, wherein the fuel gas comprises one or more of hydrogen, liquefied natural gas, liquefied petroleum gas, acetylene, and propane; and the combustion supporting gas comprises one or both of oxygen and air.
